(19) United States
(12) Patent Application Publication
(10) Pub. No.: US 2024/0052580 A1
(43) Pub. Date: Feb. 15, 2024

(54) DEVICE AND PROCESS FOR FORMING PREPRESSING-ASSEMBLED ASPHALT MIXTURE SURFACE LAYER

(71) Applicant: TONGJI UNIVERSITY, Shanghai (CN)

(72) Inventors: Huailei CHENG, Shanghai (CN); Weiying WANG, Shanghai (CN); Lijun SUN, Shanghai (CN); Liping LIU, Shanghai (CN)

(73) Assignee: TONGJI UNIVERSITY, Shanghai (CN)

(21) Appl. No.: 18/051,018

(22) Filed: Oct. 31, 2022

(30) Foreign Application Priority Data
Aug. 9, 2022 (CN) 202210950906.4

(51) Int. Cl. E01C 5/12; B28B 5/02

(52) U.S. Cl. CPC E01C 5/12; B28B 5/021

(57) ABSTRACT

A device for forming a prepressing-assembled asphalt mixture surface layer comprises: a wheel compaction module and a prepressing forming module. The wheel compaction module is configured to preliminarily compact a hot mix asphalt mixture. The prepressing forming module comprises a second reaction frame. A second loading device is hung at a top of the second reaction frame. An output end of the second loading device is fixedly connected to a prepressing plate. A conveyor belt passes through lower parts of the wheel compaction module and the prepressing forming module. A base is arranged on the conveyor belt. A surrounding mold is circumferentially fixed to the base. Through the prepressing module and the process, the device continuously applies a compaction load to the hot mix asphalt mixture surface layer, and effectively increases the adhesion between the aggregate and the asphalt to improve the strength of the assembled asphalt pavement.

### CROSS REFERENCE TO THE RELATED APPLICATIONS

This application is based upon and claims priority to Chinese Patent Application No. 202210950906.4, filed on Aug. 9, 2022, the entire contents of which are incorporated herein by reference.

### TECHNICAL FIELD

The present invention relates to the technical field of road engineering, and in particular, to a device and a process for forming a prepressing-assembled asphalt mixture surface layer.

### BACKGROUND

The assembled asphalt pavement has the advantages of rapid construction, controlling construction quality, weather-independent construction process and the like, and can effectively improve the pavement construction efficiency and the construction quality; meanwhile, most construction processes of the assembled pavement are finished indoors, so emission and interference to the field environment can be effectively reduced, and remarkable social benefits are achieved. Therefore, the assembled asphalt pavement has attracted more and more attention in the field of road engineering, and the development of the assembled pavement technology has gradually become one of the important research directions of road engineering.

However, at present, assembled asphalt pavement techniques consider little about the compaction and forming process of an asphalt layer. The compaction process still follows the construction compaction technology of the conventional pavement, and the concepts and methods for compaction on the assembled pavement are not innovated. In fact, after the conventional pavement is compacted, the asphalt layer can rebound to a certain degree, such that the compaction degree of the surface layer is reduced; meanwhile, the asphalt layer undergoes a large-scale cooling process from over 100° C. to room temperature, and the aggregate and the asphalt shrink and deform in the process, such that the adhesion between the aggregate and the asphalt is reduced, and the performance of the output asphalt mixture is reduced.

The above-mentioned problems are difficult to solve in the on-site construction of the conventional pavement, but the assembled pavement has the advantages of convenient and controllable device and process, such that the equipment and the process can be further considered in the compaction process of the assembled pavement to optimize the device and process for compaction forming, thereby improving the compaction effect and pavement performance of an asphalt layer.

### SUMMARY

The present invention is intended to provide a device and a process for forming a prepressing-assembled asphalt mixture surface layer, thereby solving the defects in the prior art.

In order to achieve the above objective, the present invention adopts the following technical schemes:

Provided is a device for forming a prepressing-assembled asphalt mixture surface layer, comprising: a wheel compaction module and a prepressing forming module, wherein the wheel compaction module is configured to preliminarily compact a hot mix asphalt mixture; the prepressing forming module comprises a second reaction frame; a second loading device is hung at a top of the second reaction frame; an output end of the second loading device is fixedly connected to a prepressing plate; a conveyor belt passes through lower parts of the wheel compaction module and the prepressing forming module; a base is arranged on the conveyor belt; a surrounding mold is circumferentially fixed to the base.

Preferably, the wheel compaction module comprises a first reaction frame; a first loading device is hung at a top of the first reaction frame; an output end of the first loading device is fixedly connected to a transmission mechanism; a steel wheel is arranged at a bottom of the transmission mechanism; rubber wheels are arranged on two sides of the steel wheel.

Preferably, the transmission mechanism includes: a sliding rail; the sliding rail is fixed at the output end of the first loading device; a rolling wheel group is slidably connected in the sliding rail; a connecting plate is fixed at the bottom of the rolling wheel group; and the connecting plate is used to mount the steel wheel and the rubber wheels.

Preferably, the steel wheel is a steel cylinder hub; the rubber wheels are pneumatic rubber tires; the steel wheel and the rubber wheels are driven by a motor.

Also provided is a process for forming a prepressing-assembled asphalt mixture surface layer, comprising:
S1: laying a base layer in a surrounding mold, spraying a bonding layer material on a surface of the base layer, and spreading a hot mix asphalt mixture on the base layer to keep the surface basically flat;
S2: conveying the surrounding mold to a wheel compaction module through a conveyor belt, and compressing a hot mix asphalt mixture surface layer by rolling back and forth with a steel wheel and two rubber wheels to preliminarily compact the hot mix asphalt mixture; and
S3: after the preliminary compaction, conveying the surrounding mold to a prepressing forming module through the conveyor belt, continuously prepressing the hot mix asphalt mixture surface layer by using a prepressing plate, and removing the prepressing plate after the asphalt mixture is cooled to room temperature to complete forming of the asphalt mixture surface layer.

Preferably, in step S2, when the hot mix asphalt mixture surface layer is compacted using the wheel compaction module, the repetition of rolling wheel compaction is not less than 12, and the temperature of the hot mix asphalt mixture is not less than 120° C.

Preferably, in step S3, when the hot mix asphalt mixture surface layer is continuously prepressed using the prepressing forming module, the prepressing load is increased over time, and the load is determined according to the following formula:

$$F ( t ) = \frac{β \cdot A}{Δ t} \cdot t$$

in the formula, F(t) is the prepressing loading force (in kN), A is the area of the prepressing plate (in m²), Δt is the time (in h) required for reducing the spreading temperature of the hot mix asphalt mixture to room temperature, t is the prepressing time (in h), and β is the load coefficient.

Compared with the prior art, the device and the process for forming a prepressing-assembled asphalt mixture surface layer disclosed herein have the following advantages:
the device and the process for forming a prepressing-assembled asphalt mixture surface layer disclosed herein continuously apply a compaction load to the hot mix asphalt mixture surface layer, reduce the resilient deformation of a conventional asphalt layer after compaction, constantly keep the stress contact between aggregate and the asphalt, and effectively increases the adhesion between the aggregate and the asphalt, such that the strength of the assembled asphalt pavement is improved and the service life of the assembled asphalt pavement is prolonged.

### BRIEF DESCRIPTION OF THE DRAWINGS

In order to more clearly illustrate the technical schemes in the examples of the present invention or in the prior art, the drawings required to be used in the description of the examples or the prior art are briefly introduced below. It is obvious that the drawings in the description below are merely examples of the present invention, and those of ordinary skilled in the art can obtain other drawings according to the drawings provided without creative efforts.

FIG. 1 is a schematic structural diagram of a wheel compaction module according to the present invention; and

FIG. 2 is a schematic structural diagram of a prepressing forming module according to the present invention.

In the drawings: 1—first reaction frame, 2—first loading device, 3—transmission mechanism, 31—sliding rail, 32—rolling wheel group, 33—connecting plate, 4—steel wheel, 5—rubber wheel, 6—second reaction frame, 7—second loading device, 8—prepressing plate, 9—base and 10—surrounding mold.

### DETAILED DESCRIPTION OF THE EMBODIMENTS

The technical scheme of the present invention is further described below with reference to the accompanying drawings and the examples.

### Example 1

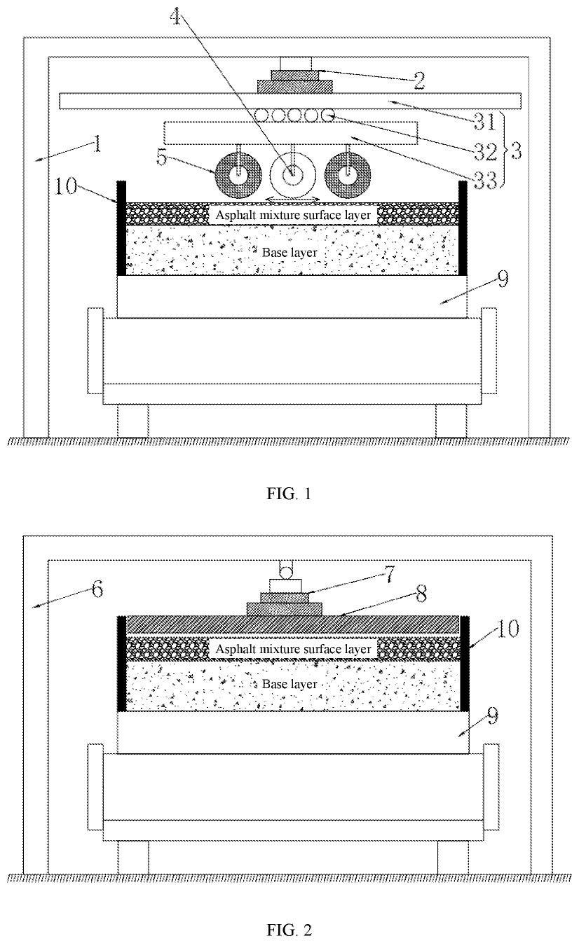

Referring to FIGS. 1-2, the present invention provides a device for forming a prepressing-assembled asphalt mixture surface layer, comprising: a wheel compaction module and a prepressing forming module, wherein the wheel compaction module is configured to preliminarily compact a hot mix asphalt mixture; the prepressing forming module comprises a second reaction frame 6; a second loading device 7 is hung at a top of the second reaction frame 6; an output end of the second loading device 7 is fixedly connected to a prepressing plate 8; a conveyor belt passes through lower parts of the wheel compaction module and the prepressing forming module; a base 9 is arranged on the conveyor belt; a surrounding mold 10 is circumferentially fixed to the base 9.

As a preferred example, the wheel compaction module comprises a first reaction frame 1; a first loading device 2 is hung at a top of the first reaction frame 1; an output end of the first loading device 2 is fixedly connected to a transmission mechanism 3; a steel wheel 4 is arranged at a bottom of the transmission mechanism 3; rubber wheels 5 are arranged on two sides of the steel wheel 4. Preferably, the first loading device 2 and the second loading device 7 are hydraulic or pneumatic devices, can realize vertical load application, have functions of adjusting the magnitude of the loading force, and can be programmed to set the loading force to dynamically change with the loading time. The surrounding mold 10 is a steel mold for circumferentially surrounding the asphalt mixture for forming.

As a preferred example, the transmission mechanism 3 comprises a sliding rail 31; the sliding rail 31 is fixed at the output end of the first loading device 2; a rolling wheel group 32 is slidably connected in the sliding rail 31; a connecting plate 33 is fixed at a bottom of the rolling wheel group 32; and the connecting plate 33 is configured to mount the steel wheel 4 and the rubber wheels 5.

As a preferred example, the steel wheel 4 is a steel cylinder hub; the rubber wheels 5 are pneumatic rubber tires; the steel wheel 4 and the rubber wheels 5 are driven by a motor. During operation, the first loading device 2 drives the transmission mechanism 3 to move down. When the steel wheel 4 and the rubber wheels 5 are in contact with the hot mix asphalt mixture, the motor drives the steel wheel 4 and the rubber wheels 5 to rotate, and the horizontal back-and-forth rolling of the steel wheel 4 and the rubber wheels 5 is realized synchronously through the rolling wheel group 32.

The present invention further provides an exemplary case for illustrating the process of forming a prepressing-assembled asphalt mixture surface layer, comprising:
S1: a base layer is laid in the surrounding mold 10, a bonding layer material is sprayed on the surface of the base layer, and a hot mix asphalt mixture is spread on the base layer to keep the surface basically flat, wherein the bonding layer material is emulsified asphalt, and the base layer may be a flexible or semi-rigid base layer of a common pavement, or may be a concrete bridge deck board or a steel bridge deck board with a bridge deck pavement structure;
S2: the surrounding mold 10 is conveyed to a wheel compaction module through a conveyor belt, and a hot mix asphalt mixture surface layer is compressed by rolling back and forth with a steel wheel 4 and two rubber wheels 5 to preliminarily compact the hot mix asphalt mixture; and
S3: after the preliminary compaction, the surrounding mold 10 is conveyed to a prepressing forming module through the conveyor belt, the hot mix asphalt mixture surface layer is continuously prepressed by using a prepressing plate 8, and the prepressing plate 8 is removed after the asphalt mixture is cooled to room temperature to complete forming of the asphalt mixture surface layer.

As a preferred example, in step S2, when the hot mix asphalt mixture surface layer is compacted using the wheel compaction module, the repetition of rolling wheel compaction is not less than 12, and the temperature of the hot mix asphalt mixture is not less than 120° C.

As a preferred example, in step S3, when the hot mix asphalt mixture surface layer is continuously prepressed using the prepressing forming module, the prepressing load is increased over time, and the load is determined according to the following formula:

$$F ( t ) = \frac{β \cdot A}{Δ t} \cdot t$$

in the formula, F(t) is the prepressing loading force (in kN), A is the area of the prepressing plate (in m²), Δt is the time (in h) required for reducing the spreading temperature of the hot mix asphalt mixture to room temperature and can be acquired according to the local actual climate and environment investigation or tests, t is the prepressing time (in h), and β is the load coefficient of which the value may be 20 and can be increased or decreased according to the compaction situation. In addition to the above formula, other forms of prepressing load can be selected according to the actual situation.

### Example 2

In Example 2, an AC-13 hot mix asphalt mixture is used for forming, and the base layer is a pre-formed cement-stabilized macadam base layer.

Firstly, a surrounding mold 10 with a proper height is selected to circumferentially surround the base layer, an emulsified asphalt is sprayed on the surface of the base layer to serve as a bonding layer material, and the AC-13 hot mix asphalt mixture is spread on the base layer according to a set thickness to keep the surface basically flat.

Then, the hot mix asphalt mixture surface layer is compressed by rolling back and forth with a steel wheel 4 and two rubber wheels 5 of a wheel compaction module to preliminarily compact the hot mix asphalt mixture; the repetition of rolling wheel compaction is 12, and the temperature of the hot mix asphalt mixture is 135° C.

Finally, the hot mix asphalt mixture surface layer is continuously prepressed using a prepressing forming module; during the continuous prepressing process, the prepressing load should be gradually increased over time. The prepressing plate 8 has an area of 10 m². After investigation and tests, the time required for reducing the spreading temperature of the hot mix asphalt mixture to room temperature is 2 h, the value of the load coefficient β is 20, and the load at different prepressing time is determined by the following formula:

$$F ( t ) = \frac{20 \cdot 10}{2} \cdot t = 100 \cdot t$$

in the formula, F(t) is the prepressing loading force (in kN) and t is the prepressing time (in h).
the asphalt mixture is cooled to room temperature, the prepressing plate 8 is removed, and the forming of the asphalt mixture surface layer is completed.

In the description of the present application, it should be noted that directions or positional relationships indicated by terms such as “upper”, “lower” and the like are those shown based on the accompanying drawings, are merely intended to facilitate and simplify description rather than to indicate or imply that the indicated device or element must have a specific direction and be structured and operated according to the specific direction, and should not be construed as limiting the present application. Unless otherwise clearly specified and defined, the terms “mount”, “interconnect” and “connect” should be understood in their broad sense. For example, the terms may be “fixedly connect”, “detachably connect” or “integrally connect”; “mechanically connect” and “electrically connect”; or “directly interconnect”, “indirectly interconnect through an intermediate” or “the communication between the interiors of two elements”. For those of ordinary skill in the art, the specific meanings of the aforementioned terms in the present application can be interpreted according to specific conditions.

It is noted that, in the present application, relational terms such as “first” and “second” are merely used to distinguish one entity or operation from another entity or operation without necessarily requiring or implying any actual relationship or order between such entities or operations. Furthermore, the terms “comprises”, “comprising”, or any other variation thereof, are intended to encompass a non-exclusive inclusion, such that a process, method, article, or device that includes a list of elements does not include only those elements but may include other elements not explicitly listed or inherent to such process, method, article, or device. Without further limitation, an element defined by the phrase “including a/an . . . ” does not exclude the presence of another identical elements in the process, method, article or device that includes the element.

The above description is only specific embodiments of the present application to enable those skilled in the art to understand or implement the present application. Various modifications to these embodiments will be apparent to those skilled in the art, and the generic principles defined herein may be implemented in other embodiments without departing from the spirit or scope of the present application. Thus, the present application is limited to these embodiments shown herein, but accords with the broadest scope consistent with the principles and novel features disclosed herein.

What is claimed is:

1. A device for forming a prepressing-assembled asphalt mixture surface layer, comprising a wheel compaction module and a prepressing forming module, wherein
the wheel compaction module is configured to preliminarily compact a hot mix asphalt mixture;
the prepressing forming module comprises a second reaction frame, wherein
a second loading device is hung at a top of the second reaction frame;
an output end of the second loading device is fixedly connected to a prepressing plate;
a conveyor belt passes through lower parts of the wheel compaction module and the prepressing forming module;
a base is arranged on the conveyor belt; and
a surrounding mold is circumferentially fixed to the base.

2. The device for forming the prepressing-assembled asphalt mixture surface layer according to claim 1, wherein
the wheel compaction module comprises a first reaction frame, wherein
a first loading device is hung at a top of the first reaction frame;
an output end of the first loading device is fixedly connected to a transmission mechanism;
a steel wheel is arranged at a bottom of the transmission mechanism; and
rubber wheels are arranged on two sides of the steel wheel.

3. The device for forming the prepressing-assembled asphalt mixture surface layer according to claim 2, wherein
the transmission mechanism comprises a sliding rail, wherein
the sliding rail is fixed at the output end of the first loading device;
a rolling wheel group is slidably connected in the sliding rail;
a connecting plate is fixed at a bottom of the rolling wheel group; and
the connecting plate is configured to mount the steel wheel and the rubber wheels.

4. The device for forming the prepressing-assembled asphalt mixture surface layer according to claim 2, wherein
the steel wheel is a steel cylinder hub; the rubber wheels are pneumatic rubber tires;
and the steel wheel and the rubber wheels are driven by a motor.

5. A process for forming a prepressing-assembled asphalt mixture surface layer, comprising:
S1: laying a base layer in a surrounding mold, spraying a bonding layer material on a surface of the base layer, and spreading a hot mix asphalt mixture on the base layer to keep the surface basically flat;
S2: conveying the surrounding mold to a wheel compaction module through a conveyor belt, and compressing a hot mix asphalt mixture surface layer by rolling back and forth a steel wheel and two rubber wheels to preliminarily compact the hot mix asphalt mixture; and
S3: after the preliminary compaction, conveying the surrounding mold to a prepressing forming module through the conveyor belt, continuously prepressing the hot mix asphalt mixture surface layer by using a prepressing plate, and removing the prepressing plate after the hot mix asphalt mixture surface layer is cooled to room temperature to complete forming of the asphalt mixture surface layer.

6. The process for forming the prepressing-assembled asphalt mixture surface layer according to claim 5, wherein
in step S2, when the hot mix asphalt mixture surface layer is compacted using the wheel compaction module, a repetition of rolling wheel compaction is not less than 12, and a temperature of the hot mix asphalt mixture is not less than 120° C.

7. The process for forming the prepressing-assembled asphalt mixture surface layer according to claim 5, wherein
in step S3, when the hot mix asphalt mixture surface layer is continuously prepressed using the prepressing forming module, a prepressing loading force is increased over time, and the prepressing loading force is determined according to the following formula:
$$F ( t ) = \frac{β \cdot A}{Δ t} \cdot t$$
in the formula, F(t) is the prepressing loading force (in kN), A is an area of the prepressing plate (in m²), Δt is a time (in h) required for reducing a spreading temperature of the hot mix asphalt mixture to room temperature, t is a prepressing time (in h), and β is a load coefficient.
